(19) United States
(12) Patent Application Publication
(10) Pub. No.: US 2005/0149965 A1
(43) Pub. Date: Jul. 7, 2005

(54) Selective media storage based on user profiles and preferences

(76) Inventor: Raja Neogi, Portland, OR (US)

Correspondence Address: Schwegman, Lundberg, Woessner & Kluth, P.A., P.O. Box 2938, Minneapolis, MN, 55402, US

(21) Appl. No.: 10/750,324

(22) Filed: Dec. 31, 2003

(51) Int. Cl. G06F 13/00; H04N 7/16; H04H 9/00; G06F 3/00; H04N 5/445

(52) U.S. Cl. 725/14

(57) ABSTRACT

In an embodiment, a method includes receiving a signal having a number of frames into a device coupled to a display. The method also includes retrieving a past viewing profile for a user of the device and at least one cue regarding viewing preferences provided by the user. Additionally, the method includes storing at least one sequence that is comprised of at least one frame based on the past viewing profile of the user of the device and the at least one cue regarding viewing preferences provided by the user.

### TECHNICAL FIELD

This invention relates generally to electronic data processing and more particularly, to selective media storage based on user profiles and preferences.

### BACKGROUND

A number of different electronic devices have been developed to assist viewers in recording and viewing of video/audio programming. One such device that is increasing in demand is the digital video recorder that allows the user to store television programs for subsequent viewing, pause live television, rewind, etc.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given reference number in a Figure is associated with the number of the Figure. For example, a system 100 can be located in FIG. 1. However, reference numbers are the same for those elements that are the same across different Figures. In the drawings:

FIG. 1 illustrates a block diagram of a system configuration for selective media storage based on user profiles and preferences, according to one embodiment of the invention.

FIG. 2 illustrates a more detailed block diagram of parts of the system configuration of FIG. 1, according to one embodiment of the invention.

FIG. 3 illustrates the different software and hardware layers for the parts of the system configuration of FIG. 1, according to one embodiment of the invention.

FIG. 4 illustrates a flow diagram for selective media storage based on user profiles and preferences, according to one embodiment of the invention.

FIG. 5 illustrates a flow diagram for selecting the sequences of media data based on user preferences/profile, according to one embodiment of the invention.

### DETAILED DESCRIPTION

Methods, apparatus and systems for selective media storage based on user profiles and preferences are described. In the following description, numerous specific details are set forth. However, it is understood that embodiments of the invention may be practiced without these specific details. In other instances, well-known circuits, structures and techniques have not been shown in detail in order not to obscure the understanding of this description. As used herein, the term “media” may include video, audio, metadata, etc.

This detailed description is divided into three sections. In the first section, one embodiment of a system is presented. In the second section, embodiments of the hardware and operating environment are presented. In the third section, embodiments of operations for video storage based on user profiles and preferences are described.

### System Overview

In this section, one embodiment of a system is presented. In one embodiment, the system illustrated herein may be a part of a set-top box, media center etc. In an embodiment, this system is within a personal video recorder (PVR).

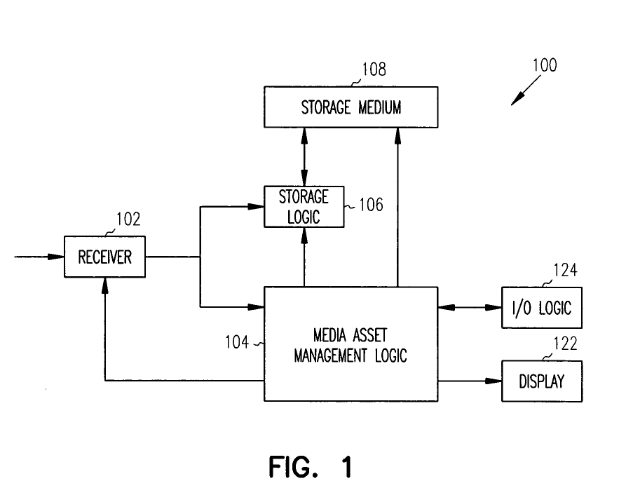

FIG. 1 illustrates a block diagram of a system configuration for selective media storage based on user profiles and preferences, according to one embodiment of the invention. In particular, FIG. 1 illustrates a system 100 that includes a receiver 102, a media asset management logic 104, a storage logic 106, a storage medium 108 and an I/O logic 124. As further described below, the storage medium 108 includes a number of different databases. While the system 100 illustrates one storage medium for these different databases, embodiments of the invention are not so limited, as such databases may be stored across a number of such mediums.

The receiver 102 is coupled to the storage logic 106 and the media asset management logic 104. The media asset management logic 104 is also coupled back to the receiver 102. The storage logic 106 is coupled to the storage medium 108. The media asset management logic 104 is coupled to the storage logic 108, the display 122, the I/O logic 124 and the storage medium 108. While the display 122 may be a number of different types of displays, in one embodiment, the video display 122 is a cathode ray tube (CRT). In an embodiment, the display 122 is a plasma display. In one embodiment, the display 112 is a liquid crystal display (LCD).

The receiver 102 is coupled to receive a signal, which, in one embodiment, is a Radio Frequency (RF) signal that includes a number of different channels of video/audio for display on the display 122. In an embodiment, this signal also includes metadata for an Electronic Programming Guide (EPG) that is not adapted to a given user of the system 100. For example, the data could include the cataloging information (e.g., source, creator and rights) and semantic information (e.g., who, when, what and where).

As further described below, in an embodiment, the media asset management logic 104 selectively stores television programs and parts thereof based on the past viewing profile of the user of the system 100. In one embodiment, the media asset management logic 104 selectively stores television programs and parts thereof based on at least one cue regarding viewing preferences provided by the user of the system 100. Such cues may include different characteristics that may be within frames of the video/audio. For example, the cues may be particular shapes, audio sequences, text within the video and/or within the close-captioning, etc. As further described below, in an embodiment, the media asset management logic 104 may also store/record a program, without commercials that are typically embedded therein.

Additionally, the media asset management logic 104 may customize the Electronic Programming Guide (EPG) for a given viewer/user of the system 100. The media asset management logic 104 registers the favorite channels and programs therein of the viewer/user based on a differentiation of channel surfing versus actual viewing of the programs by the user. To illustrate, assume that the user of the system 100 uses the EPG to select professional football for viewing on Monday nights on channel 38. Moreover, assume that the user of the system 100 uses the EPG to select the prime time news on channel 25 for viewing. Such selections are recorded in a profile database for the user. Accordingly, such selections are registered in a database in the system 100. The media asset management logic 104 may use these registered selections to customize the EPG such that the viewer/user is presented with a shortened list of channels and/or programs for viewing within the EPG.

Moreover, in an embodiment, the cues regarding viewing preferences may be inputted by the user through multimodal interfaces. For example, the user of the system 100 may select a video and/or audio sequence/clip from a program that the user is viewing. In another embodiment, the user of the system 100 may input a video and/or audio clip through other input devices. For example, the system 100 may be coupled to a computer, wherein the user may input such clips. To illustrate, the user may only desire to view the scoring highlights from a soccer match. Therefore, the user may input a video clip of a professional soccer player scoring a goal. The media asset management logic 104 may then record all of the goals scored in a given soccer match. Accordingly, because the number of goals scored in a soccer match is typically limited, the storage space for such highlights is much less in comparison to the storage space for the entire soccer match. Examples of other types of input through multimodal interfaces may include a voice of an actor or sports announcer, a voice sequence of a phrase or name (“goal”, “Jordan scores”, etc.), different shapes or textures within the video, text from close captioning, text embedded with the video, etc.

In an embodiment, the storage logic 106 receives and stores the incoming media data (video, audio and metadata) into a temporary work space within the media database 224. The media asset management logic 104 may subsequently process this media data. Based on the processing, in an embodiment, the media asset management logic 104 may store only parts of such media data based on the past viewing profile of the user and/or the cues for the different preferences from the user. Accordingly, embodiments of the invention are able to process the incoming media data in near real time and select what programs and parts thereof are to be recorded that are specific to a given user. Embodiments of the invention, therefore, may record “interesting” (relative to the user) parts of the “right” (relative to the user) programs using cues provided by the user.

### Hardware and Operating Environment

In this section, a hardware and operating environment are presented. In particular, this section illustrates a more detailed block diagram of one embodiment of parts of the system 100.

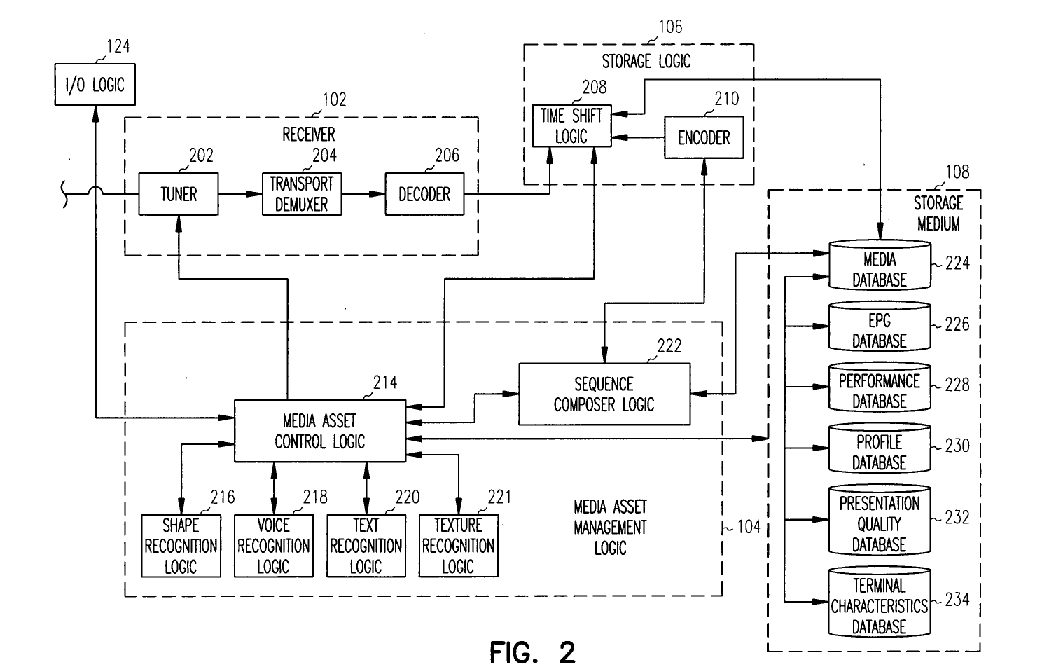

FIG. 2 illustrates a more detailed block diagram of parts of the system configuration of FIG. 1, according to one embodiment of the invention. As shown, the receiver 102 includes a tuner 202, a transport demuxer 204 and a decoder 206. The storage logic 106 includes a time shift logic 208 and an encoder 210. The media asset management logic 104 includes a media asset control logic 214, a shape recognition logic 216, a voice recognition logic 218, a text recognition logic 220, a texture recognition logic 221 and a sequence composer logic 222.

The storage medium 108 includes a media database 224, an EPG database 226, a preference database 228, a profile database 230, a presentation quality database 232 and a terminal characteristics database 234. In an embodiment, the EPG database 226 is representative of at least two different EPG databases. The first EPG database stores the EPG exported by the service provider of the media data signal (e.g., the cable or satellite television service providers). The second EPG database stores EPGs that are specific to the users of the system 100 based on the selective media storage operations, which are further described below.

The tuner 202 is coupled to receive a media data signal from the service provider. The tuner 202 is coupled to the transport demuxer 204. The transport demuxer 204 is coupled to the decoder 206. The decoder 206 is coupled to the time shift logic 208. The encoder 210 is coupled to the time shift logic 208. The time shift logic 208 is coupled to the media database 224.

The media asset control logic 214 is coupled to the tuner 202, the shape recognition logic 216, the voice recognition logic 218, the text recognition logic 220, the texture recognition logic 221, the sequence composer logic 222, the time shift logic 208 and the I/O logic 124. The media asset control logic 214 is also coupled to the EPG database 112, the preference database 114, the profile database 116, the presentation quality database 118 and the terminal characteristics database 120. The sequence composer logic 222 is coupled to the encoder 210 and the EPG database 226.

The time shift logic 208 is coupled to the media database 224. The media asset management logic 104 is coupled to the EPG database 226, the preference database 228, the profile database 230, the presentation quality database 232 and the terminal characteristics database 234. The presentation quality database 232 stores the configuration information regarding the quality of the video being stored and displayed on the display 122. Such configuration information may be configured by the user of the system 100 on a program-by-program basis. Accordingly, the media asset management logic 104 may use the presentation quality database 232 to determine the amount of data to be stored for a program. The terminal characteristics database 234 stores data related to the characteristics of the display 122 (such as the size of the screen, number of pixels, number of lines, etc.). Therefore, the media asset management logic 104 may use these characteristics stored therein to determine how to configure the video for display on the display 122.

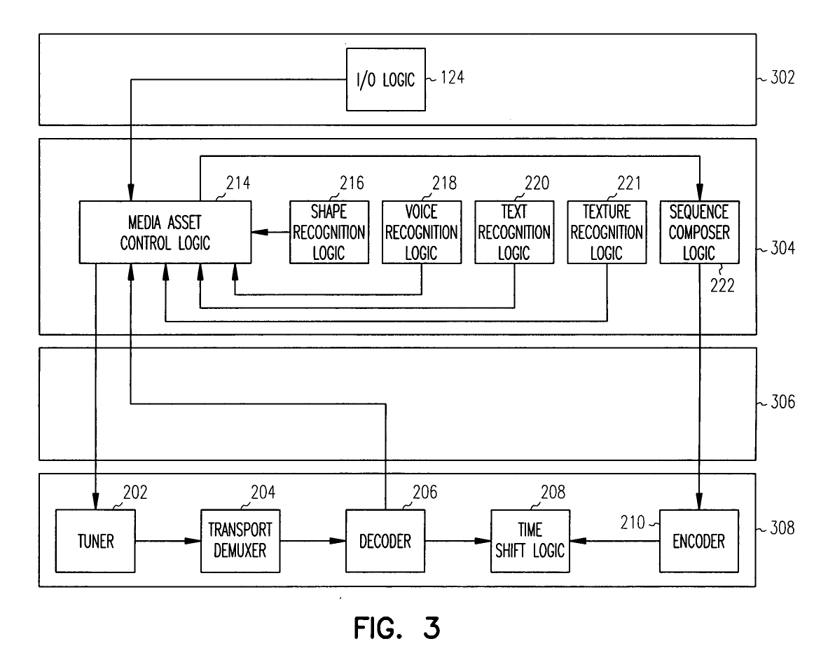

While different components of the system 100 illustrated in FIG. 2 can be performed in different combinations of hardware and software, one embodiment of the partitioning of the different components of the system 100 into different software and hardware layers is now described. In particular, FIG. 3 illustrates the different software and hardware layers for the parts of the system configuration of FIG. 1, according to one embodiment of the invention. FIG. 3 illustrates a user interface layer 302, an application layer 304, a resource management layer 306 and a hardware layer 308.

The user interface layer 302 includes the I/O logic 124. As further described below, the I/O logic 124 receives input from the user for controlling and configuring the system 100. For example, the I/O logic 124 may receive different cues for preferences from the user via different multimodal interfaces. In one embodiment, an input source may be a remote control that has access to multimodal interfaces (e.g., voice, graphics, text, etc.) As shown, the I/O logic 124 is coupled to forward such input to the media asset control logic 214.

The application layer 304 includes the media asset control logic 214, the shape recognition logic 218, the text recognition logic 220, the texture recognition logic 221 and the sequence composer logic 222. The resource management layer 306 includes components therein (not shown) that manages the underlying hardware components. For example, if the hardware layer 308 includes multiple decoders 206, the resource management layer 306 allocates decode operations across the different decoders 206 based on availability, execution time, etc. The hardware layer 308 includes the tuner 202, the transport demuxer 204, the decoder 206, the time shift logic 208 and the encoder 210.

Embodiments of the invention are not limited to the layers and/or the location of components in the layers illustrated in FIG. 3. For example, in another embodiment, the decoder 206 and/or the encoder 210 may be performed by software in the application layer 304.

### Selective Media Storage Operations Based on User Profiles/Preferences

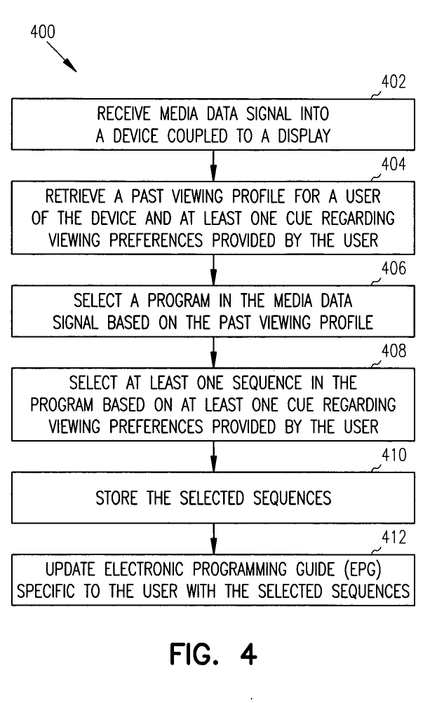

Embodiments of selective media storage operations based on user profiles/preferences are now described. In particular, embodiments of the operations of the system 100 are now described. FIG. 4 illustrates a flow diagram for selective media storage based on user profiles and preferences, according to one embodiment of the invention.

In block 402, a media data signal is received into a device coupled to a display. With reference to the embodiment of FIG. 2, the tuner 202 receives the media data signal. In an embodiment, the media signal that includes a number of different channels having a number of different programs for viewing. Control continues at block 404.

In block 404, a past viewing profile for a user of the device and at least one cue regarding viewing preferences provided by the user is retrieved. With reference to the embodiment of FIG. 2, the media asset control logic 214 retrieves the past viewing profile of the user of the system 100 from the profile database 230. The media asset control logic 214 generates the profile for a user of the system 100 based on the viewing habits of the user. In particular, the media asset control logic 214 monitors what the user of the system 100 is viewing on the display 122. For example, the user may be viewing an incoming program (independent of the recording operations of the system 100) through the tuner 202 and/or a different tuner (not shown). Accordingly, the media asset control logic 214 registers the metadata for such programs into the profile database 230. Additionally, the media asset control logic 214 may monitor the programs recorded and stored in the media database 224, in conjunction with and/or independent of the recording operations described herein. For example, the user of the system 100 may request the recording of a program that is independent of the video storage operations described herein. In an embodiment, the media asset control logic 214 differentiates surfing of the channels versus actual viewing of the program. In one such embodiment, the media asset control logic 214 makes this differentiation based on the length of time the viewer is viewing the program. For example, if the viewer watches more than 20% of a given program (either consecutively and/or disjointly), the media asset control logic 214 registers this program.

In an embodiment, the media asset control logic 214 also retrieves at least one cue regarding viewing preferences provided by the user of the system 100 from the preference database 228. As described above, the user of the system 100 may input viewing preferences into the system 100 through the I/O logic 124. In particular, the user of the system 100 may input video sequences, clip art, audio sequences, text, etc. through a number of different multimodal interfaces. Control continues at block 406.

In block 406, a program in the media data signal is selected based on the past viewing profile of the user. With reference to the embodiment of FIG. 2, the media asset control logic 214 selects the program on a channel that is within the media data signal. In an embodiment, the tuner 202 receives the media data signal. In an embodiment, the tuner 202 converts the media data signal (that is received) into a program transport stream based on the channel that is currently selected for viewing. In one embodiment, the media asset control logic 214 controls the tuner 202 to be tuned to a given channel. For example, based on the preferences of the user, the media asset control logic 214 determines that highlights of a soccer match on channel 28 are to be recorded. Therefore, the media asset control logic 214 causes the tuner to tune to channel 28.

In given situations, multiple programs across multiple channels (which are considered to be “favorites” for the user and part of the profile for the user) are being received within the media data signal for viewing at the same time. In one embodiment, the media asset control logic 214 prioritizes which of such programs are to be selected. The media asset control logic 214 may store a priority list for the different “favorite” programs based on user configuration, the relative viewing time of the different “favorite” programs, etc. For example, the viewer may have viewed 100 different episodes of a given situational comedy, while only having viewed 74 different professional soccer matches. Therefore, if a time conflict arises, the media asset control logic 214 selects the situational comedy. Moreover, while the system 100 illustrates one tuner 202, embodiments of the invention are not so limited, as the system 100 may include a greater number of such tuners. Accordingly, the media asset control logic 214 may resolve time conflicts between multiple “favorite” programs based on different tuners tuning to the different programs for processing by the media asset control logic 214. Control continues at block 408.

In block 408, at least one sequence in the program is selected based on the at least one cue regarding viewing preferences provided by the user. With reference to the embodiment of FIG. 2, the media asset management logic 104 selects this at least one sequence. In particular, the tuner 202 outputs the transport stream (described above) to the transport demuxer 204. The transport demuxer 204 de-multiplexes the transport stream into a video stream and an audio stream and extracts metadata for the program. In one embodiment, the transport demuxer 204 de-multiplexes the single program stream based on a Program Association Table (PAT) and a Program Management Table (PMT) that are embedded in the stream. The transport demuxer 204 reads the PAT to locate the PMT. The transport demuxer 204 indexes into the PMT to locate the program identification for the program or parts thereof to be recorded. The transport demuxer 204 outputs the video stream, audio stream and metadata to the decoder 206.

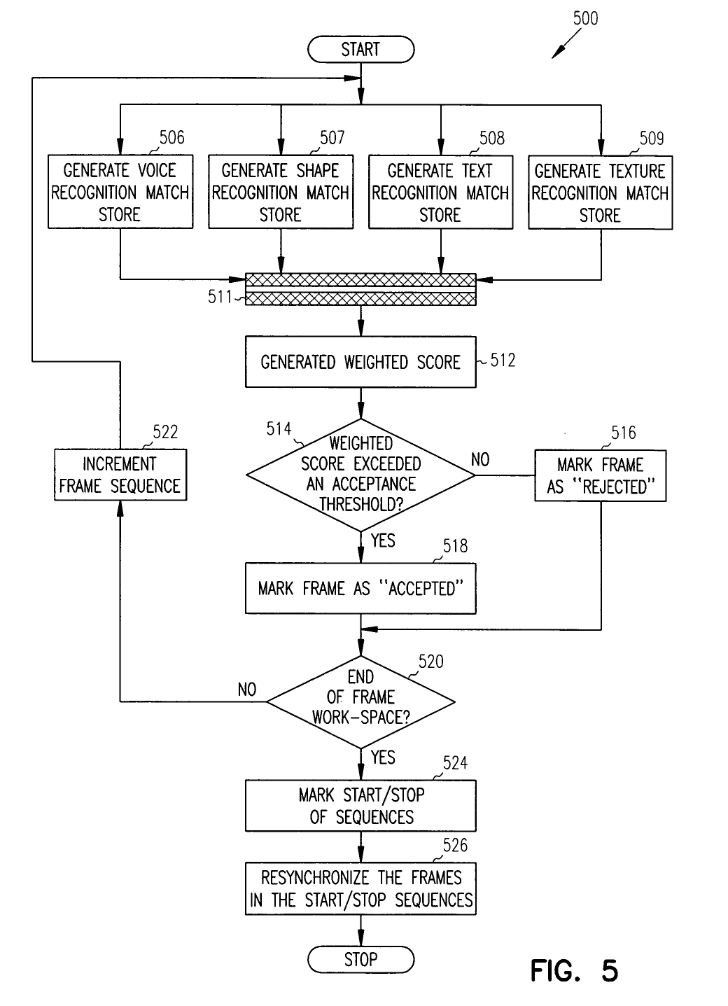

The decoder 206 decompresses the video, audio and metadata to generate video frames, audio frames and metadata. In an embodiment, the decoder 205 marks the frames with a timeline annotation. For example, the first frame includes an annotation of one, the second frame includes an annotation of two, etc. The decoder 206 outputs these frames to the time shift logic 208. In an embodiment, the time shift logic 208 receives and stores these frames into a temporary workspace within the media database 224. Additionally, the time shift logic 208 transmits these video, audio and metatdata frames to the media asset control logic 214 within the media asset management logic 104. Components in the media asset management logic 104 selects the at least one sequence in the program. A more detailed description of this selection operation is described in more detail below in conjunction with the flow diagram 500 of FIG. 5. Control continues at block 410.

In block 410, the selected sequences are stored. With reference to the embodiment of FIG. 2, the media asset control logic 214 stores the selected sequences into the media database 224. Moreover, in an embodiment, media asset control logic 214 updates the three index tables (one for normal play, one for fast forward and one for fast reverse) in reference to the selected sequences. Control continues at block 412.

In block 412, the Electronic Programming Guide (EPG) specific to the user is updated with the selected sequences. With reference to the embodiment of FIG. 2, the sequence composer logic 222 updates the EPG specific to the user with the selected sequences. In an embodiment, the EPG for the user is stored in the EPG database 226. The EPG is a guide that may be displayed to the user on the display 122 that includes the different programs and sequences within programs that are stored in the system 100 for viewing by the user. Accordingly, when selected sequences are stored that are specific to the user based on their profile and preferences, the EPG for the user is updated with such sequences. For example, if the media asset management logic 104 stores scoring highlights from a soccer match for the user, the EPG is updated to reflect the storage of these highlights.

In an embodiment, the sequence composer logic 222 generates a metadata table that is stored in the media database 224. The metadata table includes metadata related to the frames within the selected sequences. Such metadata includes cataloging information (source, creator, rights), semantic information (who, when, what, where) and generated structural information (e.g., motion characteristics or face signature, caption keywords, voice signature, etc.). In an embodiment, the EPG for this user references this metadata table.

A more detailed description of the selection of sequences within a program based viewing preferences of a user is now described. In particular, FIG. 5 illustrates a flow diagram for selecting the sequences of media data based on user preferences/profile, according to one embodiment of the invention. The operations of the flow diagram 500 are for a given number of frames that are stored in a temporary workspace. In one embodiment, a temporary workspace for a number of frames is allocated within the media database 224. Therefore, the operations of the flow diagram 500 may be repeatedly performed on the frames for a selected program to which the tuner 202 is tuned. For example, this temporary workspace may be 10 minutes of media data frames. However, embodiments of the invention are not so limited. For example, in another embodiment, the operations of the flow diagram 500 may be performed while the frames are received from the time shift logic 208. Additionally, in an embodiment, the operations of the flow diagram 500 are repeated until the frames of the selected program have been processed.

The operations of the flow diagram 500 commence in blocks 506, 507, 508 and 509. As shown, in an embodiment, the operations within the blocks 506, 507, 508 and 509 are performed in parallel at least in part by different logic within the system 100. Moreover, in an embodiment, the operations of the flow diagram 500 remain at point 511 until each of the operations in blocks 506, 507, 508 and 509 are complete. However, embodiments of the invention are not so limited. For example, in one embodiment, a same logic may serially perform each of the different operations in blocks 506, 507, 508 and 509. Additionally, in an embodiment, the operations in blocks 506, 507, 508, 509, 512, 514, 516, 518, 520 and 522 are for a given frame.

In block 506, a voice recognition match score is generated. With reference to the embodiment of FIG. 2, the voice recognition logic 218 generates the voice recognition score. In particular, the media asset control logic 214 transmits voice-related preferences for the user along with the frame of audio. The voice recognition logic 218 generates this score based on how well the voice-related preferences match the audio in the frame. For example, there may be 50 different voice-related preferences, which are each compared to the audio in the frame. To illustrate, these voice-related preferences may be different audio clips that the user has inputted as a preference. A first audio clip could be the voice of a sport announcer saying “Jordan scores.” A second audio clip could be the voice of a favorite actor. In an embodiment, the voice recognition logic 218 performs a comparison of a preference to the audio in the frame based on the catalog (source, creator, rights) and the semantic (who, when, what, where) information associated with the preference and the frame. For example, if a given frame is related to a basketball game, only those preferences that are from and/or related to a basketball game are compared to the audio in the frame. In an embodiment, the voice recognition logic 218 generates an eight bit (0-255) normalized component match score. Accordingly, the voice recognition logic 218 generates a relative high match score if likelihood of a match between one of the voice-related preferences and the audio in the frame is high. The voice recognition logic 218 outputs the voice recognition match score to the media asset control logic 214. Control continues at block 512.

In block 507, a shape recognition match score is generated. With reference to the embodiment of FIG. 2, the shape recognition logic 216 generates the shape recognition match score. In particular, the media asset control logic 214 transmits shape-related preferences for the user along with the frame of video. The shape recognition logic 216 generates this score based on how well the shape-related preferences match the shapes in the frame of the video. For example, there may be 25 different shape-related preferences, which are compared to the shapes in the frame. To illustrate, these shape-related preferences may include the faces of individuals, the shapes involving a player scoring a goal in soccer or basketball, text that shows the score of a sporting event, etc. In an embodiment, the shape recognition logic 216 performs a comparison of a preference to the shapes in the frame based on the catalog and the semantic information associated with the preference and the frame. In an embodiment, the shape recognition logic 216 generates an eight bit (0-255) normalized component match score. Accordingly, the shape recognition logic 216 generates a relative high match score if likelihood of a match between one of the shape-related preferences and the shapes in the frame is high. The shape recognition logic 216 outputs the shape recognition match score to the media asset control logic 214. Control continues at block 512.

In block 508, a text recognition match score is generated. With reference to the embodiment of FIG. 2, the text recognition logic 220 generates the text recognition match score. In particular, the media asset control logic 214 transmits text-related preferences for the user along with the close-captioned text associated with the frame. The text recognition logic 220 generates this score based on how well the text-related preferences match the close-captioned text associated with the frame. For example, there may be 40 different text-related preferences, which are compared to the close-captioned text associated with the frame. To illustrate, these text-related preferences may include text that is generated in close captioning for a program or sequence thereof. For example, the text could be the name of a character in a movie, the name of the movie, the name of the sports announcer, sports athlete, etc. In an embodiment, the text recognition logic 220 performs a comparison of a preference to the close-captioned text in the frame based on the catalog and the semantic information associated with the preference and the frame. In an embodiment, the text recognition logic 220 generates an eight bit (0-255) normalized component match score. Accordingly, the text recognition logic 220 generates a relative high match score if likelihood of a match between one of the text-related preferences and the close-captioned text in the frame is high. The text recognition logic 220 outputs the text recognition match score to the media asset control logic 214. Control continues at block 512.

In block 509, a texture recognition match score is generated. With reference to the embodiment of FIG. 2, the texture recognition logic 221 generates the texture recognition match score. In particular, the media asset control logic 214 transmits texture-related preferences for the user along with the frame of video. The texture recognition logic 221 generates this score based on how well the texture-related preferences match the texture in the frame of the video. For example, there may be 15 different texture-related preferences, which are compared to the different textures in the frame. To illustrate, these shape-related preferences may include the texture of a football field, a basketball court, a soccer field, etc. In an embodiment, the texture recognition logic 221 performs a comparison of a preference to the textures in the frame based on the catalog and the semantic information associated with the preference and the frame. In an embodiment, the texture recognition logic 221 generates an eight bit (0-255) normalized component match score. Accordingly, the texture recognition logic 221 generates a relative high match score if likelihood of a match between one of the texture-related preferences and the textures in the frame is high. The texture recognition logic 221 outputs the texture recognition match score to the media asset control logic 214. Control continues at block 512.

In block 512, a weighted score is generated. With referenced to the embodiment of FIG. 2, the media asset control logic 214 generates the weighted score for this frame. In particular, the media asset control logic 214 generates this weighted score based on the voice recognition match score, the shape recognition match score, the text recognition match score and the texture recognition match score. In an embodiment, the media asset control logic 214 assigns a weight to these different component match scores based on the type of programming. For example, for sports-related programs, the media asset control logic 214 may use a weighted combination of voice, shape and text. For home shopping-related programs, the media asset control logic 214 may use a weighted combination of voice, texture and text.

Table 1 shown below illustrates one example of the assigned weights for the different component match scores based on the type of programming.

TABLE 1

| | Weights per Component Type | | | | |
|---|---|---|---|---|---|
| Programming Type | Shape | Texture | Voice | Text | Hit % |
| Sports/Soccer/World-Cup | 0.33 | — | 0.34 | 0.33 | 100 |
| Sports/Basketball/NBA | 0.20 | — | 0.40 | 0.40 | 100 |
| News/TV/commercials | — | 0.33 | 0.33 | 0.34 | 75 |
| Business/home-shopping/jewelry | — | 0.33 | 0.27 | 0.40 | 100 |

In one embodiment, the media asset control logic 214 determines the type of program based on the semantic metatdata that is embedded in the media data signal being received into the system 100. The media asset control logic 214 multiplies the weights by the associated component match score and adds the multiplied values to generate the weighted score. Control continues at block 514.

In block 514, a determination is made of whether the weighted score exceeds an acceptance threshold. With reference to the embodiment of FIG. 2, the media asset control logic 214 makes this determination. In an embodiment, the acceptance threshold is a value that may be configurable by the user. Therefore, the user may allow for more or less tolerance for the recording of certain unintended video sequences. In one embodiment, the acceptance threshold is based on the size of the storage medium. For example, if the size of the storage medium 108 is 80 Gigabytes, the acceptance threshold may be less in comparison to a system 108 wherein the size of the storage medium 108 is 40 Gigabytes.

In block 516, upon determining that the weighted score does not exceed the acceptance threshold, the frame is marked as “rejected.” With reference to the embodiment of FIG. 2, the media asset control logic 214 marks this frame as “rejected.” Accordingly, such frame will not be stored in the media database 224 for possible subsequent viewing by the user. Control continues at block 520, which is described in more detail below.

In block 518, upon determining that the weighted score is equal to or exceeds the acceptance threshold, the frame is marked as “accepted.” With reference to the embodiment of FIG. 2, the media asset control logic 214 marks this frame as “accepted.” Accordingly, such frame will be stored in the media database 224 for possible subsequent viewing by the user. Control continues at block 520.

In block 520, a determination is made of whether the end of the frame workspace has been reached. With reference to the embodiment of FIG. 2, the media asset control logic 214 makes this determination. In particular, in one embodiment, a temporary workspace for a number of frames is allocated within the media database 224. Accordingly, the operations of the flow diagram 500 are for a given number of frames in this workspace. Therefore, the operations of the flow diagram 500 may be repeatedly performed on the frames for the given channel to which the tuner 202 is tuned. For example, this temporary workspace may be 10 minutes of video/audio frames. However, embodiments of the invention are not so limited. For example, in another embodiment, the operations of the flow diagram 500 may be performed while the frames are received from the time shift logic 208.

In block 522, upon determining that the end of the frame workspace has not been reached, the frame sequence is incremented. With reference to the embodiment of FIG. 2, the media asset control logic 214 increments the frame sequence. As described above, in an embodiment, the decoder 206 marks the frames with timeline annotations, which serve as the frame sequence. The media asset control logic 214 increments the frame sequence to allow for the processing of the next frame within the frame workspace. Control continues at blocks 506, 507, 508 and 509, wherein the match scores are generated for the next frame in the frame workspace. Therefore, the operations in blocks 506, 507, 508, 509, 512, 514, 516, 518, 520 and 522 continue until all of the frames in the frame workspace have been marked with as “rejected” or “accepted.” Because the voices, shapes, text and texture for frames change slowly over time, a series of consecutive frames (e.g., 2 minutes of video) are typically marked as “accepted”, which are followed by a series of frames that are marked as “rejected”, etc. For example, if 5000 frames include the video of a soccer player scoring a goal, which matches one of the preferences of the user, the 5000 frames are marked as “accepted.”

In block 524, upon determining that the end of the frame workspace has been reached, the start/stop sequences are marked. With reference to the embodiment of FIG. 2, the sequence composer logic 222 marks the start/stop sequences. The sequence composer logic 222 marks the start/stop sequences of the frames based on the marks of “rejected” and “accepted” for the frames. The sequence composer logic 222 marks the start sequence from the first frame that is marked as “accepted” that is subsequent to a frame that is marked as “rejected.”The sequence composer logic 222 marks the stopping point of this sequence for the last frame that is marked as “accepted” that is prior to a frame that is marked as “rejected.” Therefore, the sequence composer logic 222 may mark a number of different start/stop sequences that are to be stored in the media database 224, which may be subsequently viewed by the user. In an embodiment, a start/stop sequence continues from one frame workspace to a subsequent frame workspace. Therefore, the sequence composer logic 222 marks start/stop sequences across a number of frame workspaces. Control continues at block 526.

In block 526, the frames in the start/stop sequences are resynchronized. With reference to the embodiment of FIG. 2, the sequence composer logic 222 resynchronizes the frames in the start/stop sequences. In an embodiment, the sequence composer logic 222 resynchronizes by deleting the frames that are not in the start/stop sequences (those frames marked as “rejected”). In an embodiment, the sequence composer logic 222 defragments the frame workspace by moving the start/stop sequences together for approximately continuous storage therein. Accordingly, this de-fragmentation assists in efficiently usage of the storage in the media database 224. In an embodiment, the sequence composer logic 222 transmits the resynchronized start/stop sequences to the encoder 210. The encoder 210 encodes these sequences, prior to storage into the media database 224. The operations of the flow diagram 500 are complete.

While the flow diagram 500 illustrates four different component match scores for the frames, embodiments of the invention are not so limited, as a lesser or greater number of such component match scores may be incorporated into the operations of the flow diagram 500. For example, in another embodiment, a different component match score related to the colors, motion, etc. in the frame of video could be generated and incorporated into the weighted score.

Moreover, the flow diagram 500 may be modified to allow for the recording/storage of a program without the commercials that may be embedded therein. In particular, the flow diagram 500 illustrates the comparison between characteristics in a frame and preferences of the user/viewer. However, in an embodiment, the characteristics in a frame may be compared to characteristics of commercials (similar to blocks 506-509). A weighted score is generated which provides an indication of whether the frame is part of a commercial. Accordingly, such frames are marked as “rejected”, while other frames are marked as “accepted”, thereby allowing for the storage of the program independent of the commercials.

While the characteristics of commercials may be determine based on a number of different operations, in one embodiment, the viewer/user may train the system 100 by inputting a signal into the I/O logic 124 at the beginning point and ending point of commercials while viewing programs. Therefore, the media asset management logic 104 may process the frames within these marked commercials to extract relevant shapes, audio, text, texture, etc. Such extracted data may be stored in the storage medium 108.

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for selective media storage based on user profiles and preferences, in accordance with embodiments of the invention. A number of figures show flow diagrams illustrating operations for selective media storage based on user profiles and preferences. The operations of the flow diagrams will be described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagram.

In view of the wide variety of permutations to the embodiments described herein, this detailed description is intended to be illustrative only, and should not be taken as limiting the scope of the invention. To illustrate, while the system 100 illustrates one tuner 202, in other embodiments, a greater number of tuners may be included therein. Accordingly, the system 100 may record parts of two different programs that are on different channels at the same time. For example, the system 100 may record highlights of a soccer match on channel 55 using a first tuner, while simultaneously, at least in part, recording a movie without the commercials on channel 43. What is claimed as the invention, therefore, is all such modifications as may come within the scope and spirit of the following claims and equivalents thereto. Therefore, the specification and drawings are to be regarded in an illustrative rather than a restrictive sense.

1. A method comprising:
receiving a signal having a number of frames into a device coupled to a display;
retrieving a past viewing profile for a user of the device and at least one cue regarding viewing preferences provided by the user; and
storing at least one sequence that is comprised of at least one frame based on the past viewing profile of the user of the device and the at least one cue regarding viewing preferences provided by the user.

2. The method of claim 1, further comprising updating an electronic programming guide associated with the user with identification of the at least one sequence that is stored.

3. The method of claim 1, wherein storing the at least one sequence based on the past viewing profile of the user of the device and the at least one cue regarding viewing preferences provided by the user comprises generating weighted scores for the number of frames based on a programming type for a program in a channel of the signal.

4. The method of claim 1, further comprising receiving the at least one cue from the user through a multimodal interface.

5. The method of claim 3, wherein receiving the at least one cue from the user through the multimodal interface comprises receiving a video sequence from the user through the multimodal interface.

6. The method of claim 3, wherein receiving the at least one cue from the user through the multimodal interface comprises receiving an audio sequence from the user through the multimodal interface.

7. The method of claim 3, wherein receiving the at least one cue from the user through the multimodal interface comprises receiving text from the user through the multimodal interface.

8. The method of claim 1, further comprising updating an electronic programming guide associated with the user based on the past viewing profile for the user of the device.

9. A method comprising:
receiving a signal that includes a number of frames into a device coupled to a display;
retrieving at least one cue related to preferences of a viewer of the display, wherein the at least one cue is selected from the group consisting of a video sequence, an audio sequence, text; and
performing the following operations for a frame of the number of frames:
generating a match score based on a comparison between at least one characteristic of the frame and the at least one cue; and
storing the frame upon determining that the match score for the frame exceeds an acceptance threshold.

10. The method of claim 9, wherein performing the following operations for the frame of the number of frames further comprises deleting the frame upon determining that the match score for the frame does not exceed the acceptance threshold.

11. The method of claim 9, further comprising updating an electronic programming guide associated with the user with identification of the frames of the number of frames that are stored.

12. The method of claim 9, further comprising receiving the at least one cue from the user through a multimodal interface.

13. The method of claim 9, wherein generating the match score based on the comparison between the at least one characteristic of the frame and the at least one cue comprises generating the match score based on at least two comparisons between at least two characteristics and at least two cues, wherein the at least two comparisons are weighted based on a programming type for a program of which the number of frames are within.

14. An apparatus comprising:
a storage medium; and
a media asset management logic to receive frames of a program on a channel in a signal and to selectively store less than all of the frames into the storage medium based on at least one cue related to at least one viewing preference provided by the user.

15. The apparatus of claim 14, wherein the media asset management logic is to selectively store less than all of the frames based on a weighted score for frames, wherein weights of the weighted score are based on a programming type for the program.

16. The apparatus of claim 14, wherein the storage medium is to store an electronic programming guide associated with the user, wherein the media asset management logic is to update the electronic programming guide with identifications of the video that is to be selectively stored.

17. The apparatus of claim 14, further comprising an input/output logic to receive, through a multimodal interface, the at least one cue from the user, wherein the at least one cue is selected from a group consisting of a video sequence, an audio sequence, and text.

18. A system comprising:
a storage medium;
an input/output (I/O) logic to receive at least one cue related to viewing preferences of a user of the system;
a tuner to receive a signal that includes a number of channels;
a media asset management logic to cause the tuner to tune to a channel of the number of channels based on a viewing profile of a user of the system, wherein the media asset management logic comprises:
a management control logic to generate a match score for a frame of a number of frames within a program on the channel based on a comparison between at least one characteristic in the frame and the at least one cue, wherein the management control logic is to mark the frame as acceptable if the match score exceeds an acceptance threshold; and
a sequence composer logic is to store, in the storage medium, at least one sequence that comprises at least one frame that is marked as acceptable; and
a cathode ray tube display to display the at least one sequence.

19. The system of claim 18, wherein the match score is a composite weighted score for the frame based on comparisons between at least two characteristics in the frame and at least two cues.

20. The system of claim 18, wherein the at least two characteristics in the frame are selected from the group consisting of shapes, text and audio.

21. The system of claim 18, wherein the composite weighted score is weighted based on a programming type for the program.

22. The system of claim 14, wherein the sequence composer logic is to update an electronic programming guide specific to the user based on the at least one sequence that is to be stored.

23. A machine-readable medium that provides instructions, which when executed by a machine, cause said machine to perform operations comprising:
receiving a signal having a number of frames into a device coupled to a display;
retrieving a past viewing profile for a user of the device and at least one cue regarding viewing preferences provided by the user; and
storing at least one sequence that is comprised of at least one frame based on the past viewing profile of the user of the device and the at least one cue regarding viewing preferences provided by the user.

24. The machine-readable medium of claim 23, further comprising updating an electronic programming guide associated with the user with identification of the at least one sequence that is stored.

25. The machine-readable medium of claim 23, wherein storing the at least one sequence based on the past viewing profile of the user of the device and the at least one cue regarding viewing preferences provided by the user comprises generating weighted scores for the number of frames based on a programming type for a program in a channel of the signal.

26. The machine-readable medium of claim 23, further comprising updating an electronic programming guide associated with the user based on the past viewing profile for the user of the device.

27. A machine-readable medium that provides instructions, which when executed by a machine, cause said machine to perform operations comprising:
receiving a signal that includes a number of frames into a device coupled to a display;
retrieving at least one cue related to preferences of a viewer of the display, wherein the at least one cue is selected from the group consisting of a video sequence, an audio sequence, text; and
performing the following operations for a frame of the number of frames:
generating a match score based on a comparison between at least one characteristic of the frame and the at least one cue; and
storing the frame upon determining that the match score for the frame exceeds an acceptance threshold.

28. The machine-readable medium of claim 27, wherein performing the following operations for the frame of the number of frames further comprises deleting the frame upon determining that the match score for the frame does not exceed the acceptance threshold.

29. The machine-readable medium of claim 27, further comprising updating an electronic programming guide associated with the user with identification of the frames of the number of frames that are stored.

30. The machine-readable medium of claim 27, wherein generating the match score based on the comparison between the at least one characteristic of the frame and the at least one cue comprises generating the match score based on at least two comparisons between at least two characteristics and at least two cues, wherein the at least two comparisons are weighted based on a programming type for a program of which the number of frames are within.
